(19) United States
(12) Patent Application Publication
(10) Pub. No.: US 2018/0285479 A1
(43) Pub. Date: Oct. 4, 2018

(54) SCALABLE AUDIT ANALYTICS

(71) Applicant: Superna Inc., Ottawa (CA)

(72) Inventors: Andrew Mackay, Ontario (CA); Kyle Fransham, Ottawa (CA)

(21) Appl. No.: 15/943,190

(22) Filed: Apr. 2, 2018

Related U.S. Application Data
(60) Provisional application No. 62/480,703, filed on Apr. 3, 2017.

(51) Int. Cl. G06F 17/30; G06F 21/62; G06F 21/56

(52) U.S. Cl. CPC G06F 17/30979; G06F 21/6218; G06F 2221/034; G06F 17/30946; G06F 21/56

(57) ABSTRACT

The present invention provides a method to translate audit record data from NAS systems into distributed multi storage and query node structure to allow parallel search and analytical queries to be scaled to millions or billions of records. This invention covers translation and transformation of data, relational query schema and methods to access and analyze audit data for specific patterns of user data access behavior for the purpose of securing the data. A system that allows external auditors to validate the integrity of an audit record and ensure immutable audit records stored on commodity storage devices. Modern enterprise-grade NAS devices are capable of generating massive amounts of audit data, with events rates of hundreds of millions of events per day. This invention provides a method to archive, search, and cryptographically sign the audit events to ensure long term persistence and immutability of the enterprise's file activity.

### CROSS-REFERENCE TO RELATED APPLICATIONS

This application claims priority to U.S. Provisional Patent Application Ser. No. 62/480,703 filed Apr. 3, 2017, which is hereby incorporated by reference herein in its entirety.

### TECHNICAL FIELD

The present invention pertains to the field of file access and security auditing analytics, for example in support of compliance, security investigations, malware and ransomware file access detection.

### BACKGROUND

File based storage has grown at a double-digit rate for many years and the IOT (internet of things) along with utility metering and video surveillance has recently driven the growth of files and storage products traditionally called Network Attached Storage arrays or NAS (Network Attached Storage) devices.

NAS devices support auditing features which generate audit records when files are accessed and manipulated. Examples of file manipulations include read, write, rename, delete, and security change operations.

NAS devices support features usable to lock records using proprietary methods without the ability to move these files to general purpose storage and no ability to have the locked files validated by external 3rd party auditors, unless the auditors are physically on site.

Currently, trusted Certificate signing authorities sign HTTPS server certificates using x.509 to allow users to trust the web site they visit (for example in support of a banking application). In the same way, enterprises have a need to have their audit data signed by a 3^{rd} party so that independent auditors can trust the audit data has not been tampered with.

Certain file-based storage systems have the ability to allow access to various paths in the file system tree using SMB (Server Message Block) and NFS protocols. Access attempts can be subject to authentication challenges for validating whether each attempt is from a trusted source and is sufficiently authorized to access the data. Data accesses further trigger generation of audit logs detailing each action against the data.

Auditing and compliance rules related to data accesses can require enterprises to be able to answer questions about data access events. Such questions may include the identity of persons accessing the data, the contents of the data, the date and time of data accesses, and the access level granted to the persons. Some regulatory requirements state that many enterprises are to store audit information for several years.

The volume of audit data required to track all types of access to the data with potentially thousands of users accessing a centralized NAS systems generates potentially millions of records per day of audit logs. This creates a significant challenge when it is required, for example, to audit this data to find security events such as potential security breaches.

Traditional security audit analysis uses RDBMS (Relational Database Management System) technology to store and query records in a database. As the volume of data grows to audit 6 months, 1 year or longer periods worth of data, for ever-growing volumes of audit data, the database is required to scale at the same growth rate as the data itself.

According to some projections, scaling of the audit and analysis system would need to scale at 30-40% year over year just to keep pace with the volume of audit data generated by an ever-growing Big Data NAS system platform.

To cope with such demands, RDBMS platform can require many CPU's and very fast disk access in <2 ms access times. This in turn can require fibre channels, expensive clustered databases and specialized storage networks to maintain scalability and desired response times.

It is therefore likely that legacy RDBMS architectures will not keep pace with the current rate of audit data growth, and thus new methods to audit large volumes of file-based data will be needed.

Furthermore, Legacy RDBMS may have no way to guarantee immutable audit records or allow external 3rd party auditors to validate audit records, which can be problematic.

Therefore, there is a need for data auditing approaches that are not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

Embodiments of the present invention provide for a method and system for providing auditing analytics.

According to an aspect of the present invention, there is provided a system for processing audit events associated with computer file systems comprising: a plurality of processing modules configured to process audit event data indicative of interactions with the computer file systems in order to detect undesired instances of said interactions, each of the processing modules comprising processing circuitry; an input module configured to receive the audit event data and provide the audit event data to one or more of the plurality of processing modules for processing, the input module comprising further processing circuitry; and one or more storage modules configured to receive and store output of the plurality of processing modules, each of the storage modules comprising an electronic data storage medium.

The input module (also referred to as a data input computer device) can be a computer or virtual machine operatively coupled to a computer network. The input module may include a computer network interface for receiving and providing the audit event data, and a processor operatively coupled to memory for implementing the further processing circuitry. The further processing circuitry may be configured to manage how the audit event data is distributed to the processing modules. The processing circuitry and the further processing circuitry may each comprise a computer processor operatively coupled to memory. The processing modules (also referred to as real or virtual computer processors) and the input module may be provided using virtual machines instantiated for that purpose. Each storage module (also referred to as an electronic storage device) may further include a computer network interface for receiving information from the processing modules via an intervening data network, and a processor operatively coupled to memory for directing operation of the storage module.

According to another aspect of the present invention, there is provided an electronic system for processing audit events associated with computer file systems comprising a plurality of real or virtual computer processors configured to process audit event data indicative of interactions with the computer file systems in order to detect undesired instances of said interactions, each of the processing modules comprising processing circuitry; a data input computer device comprising a data interface and configured to receive the audit event data and provide the audit event data to one or more of the plurality of processing modules for processing, the input module comprising further processing circuitry; one or more electronic storage devices configured to receive and store output of the plurality of processing modules, each of the storage modules comprising an electronic data storage medium.

In some embodiments, the system is configured to store audit data using a lookup key derived from the audit data to allow sequential related information to be stored on disk physically located within the same file and allow indexing of this lookup key for searching. This lookup key is based on security information such as user identification, date and time of event, protocol of the action to the file system, hash of the file system path or user security identifier. This lookup key optionally points to the physical record on disk and will in some embodiments summarize the record. Optionally, the lookup key is audit security specific and allows security searches to execute in parallel across multiple electronic storage to enable faster searches.

According to another aspect of the present invention, there is provided an apparatus for storing audit record data, the audit record data indicative of interactions with a computer file system, the apparatus comprising storage management circuitry operatively coupled to a plurality of data storage media and configured to: distribute storage of the audit record data across the plurality of data storage media such that the audit record data is retrievable in parallel in response to a predetermined type of query performable on the audit record data.

According to another aspect of the present invention, there is provided an apparatus for maintaining audit record data indicative of interactions with a computer file system, comprising: processing circuitry configured to generate blockchain data indicative of the audit record data; and a network interface configured to transmit the generated blockchain data to a plurality of blockchain organizations.

According to other aspects of the present invention, there are provided one or more methods, for execution by one or more computers each having a processor operatively coupled to memory, for processing audit events, storing audit record data, and/or maintaining audit record data using blockchains. Such methods cause the computer or computers to operate as described above with respect to the provided systems and apparatuses.

### BRIEF DESCRIPTION OF THE DRAWINGS

Further features and advantages will become apparent from the following detailed description, taken in combination with the appended drawing, in which:

FIG. 1 illustrates a system for processing and storing audit data, in accordance with an embodiment of the present invention.

FIG. 2 illustrates communication of audit records to independent audit organizations, in accordance with an embodiment of the present invention.

FIG. 3 illustrates a method for processing audit information, in accordance with an embodiment of the present invention.

FIG. 4 illustrates a relational data access system, in accordance with an embodiment of the present invention.

FIG. 5 illustrates operations related to cryptographically signing and securing a consecutive series of audit events, according to an embodiment of the present invention.

It will be noted that throughout the appended drawings, like features are identified by like reference numerals.

### DETAILED DESCRIPTION

Embodiments of the present invention provide for a scalable system for processing and storing audit events. The system may include multiple parallel processing modules, such as virtual machines, and multiple parallel storage modules. Multiple processing modules may each work on the same audit event or stream of audit events, each processing module configured to detect a different type of undesired activity, such as a malicious activity, illegal or unethical activity, data theft activity, or risky activity. Each processing module may include a computer processor operatively coupled to memory and configured to execute program instructions stored in the memory. Each processing module can be provided as a virtual machine instantiated using underlying computer processing resources. A common working memory may be shared between the processors, so that each processor can access and work on shared data, such as audit events, held in the common working memory. Multiple copies of the shared data may be held in different working memories and accessed by two or more different sets of processors.

Embodiments of the present invention provide for a method and system for storing audit record data in a manner that allows relational query of the audit data to join multiple fields within the audit records and span any time period and/or that allows queries to be serviced by distributing a query to multiple nodes regardless of the total record count in the audit database.

In some embodiments, the database includes a processor configured to manage database interface operations such as queries, and computer memory for internally storing data records. In some embodiments, the data records, or information derived from the data records, may be stored in the form of a blockchain, and a computer processor operatively coupled to memory may be used to prepare the data records or related information for publication. In some embodiments, as described below, the database can include a network communication interface configured to publish the information in the form of blockchain information.

Embodiments of the present invention provide for method and apparatus for maintaining an immutable audit record of file events. The method and apparatus may be operated without necessarily needing specialized storage features. Various embodiments allow for external auditors to record and validate audit records of one or more enterprise's using a shared audit ledger. A blockchain can be used to store information related to the audit ledger, and the blockchain can be published for inspection by multiple parties.

Data indicative of audit event records can be published to a blockchain which is maintained and/or inspected by one or more parties, such as external third parties. Because the data is published to the blockchain, the audit event records cannot be easily altered without detectability of such alteration. For example, the audit records can be compared against the blockchain data to detect discrepancies. The data published to the blockchain can, for example, be an encrypted version of audit event records, or a checksum based on the audit event data, etc. Data can be published to the blockchain as audit event records as it is generated, or on a schedule, for example. An auditor inspecting the audit records can refer to the blockchain data for confirmation that the audit records have not been altered. One or more processors can receive the data records, generate blockchain data based on the data records, and provide the blockchain data for storage in computer memory. For publication, the computer memory may be accessible to external parties. In some cases, the blockchain data may be transmitted to the computers of one or more external parties via a network interface.

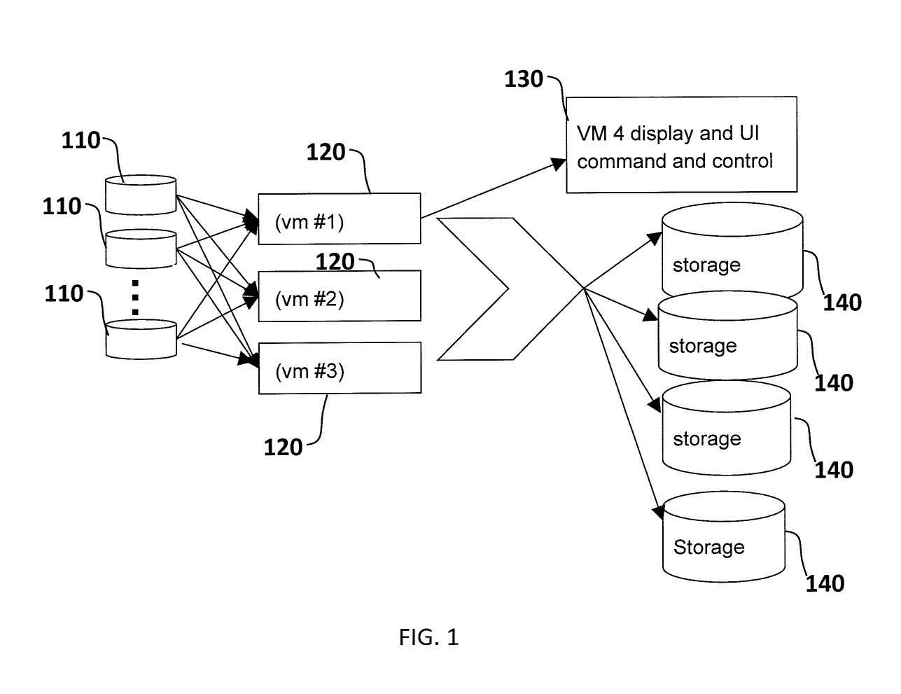

FIG. 1 shows a system provided in accordance with an embodiment of the present invention.

The system includes one or more computing devices configured into a plurality of virtual machines 120, referred to as processing virtual machines (VMs). The computing devices each include computer processors operatively coupled to memory and a network interface. The virtual machines may each operate, from a functional perspective, as self-contained computing devices using the underlying hardware of the computing devices, as would be readily understood by a worker skilled in the art.

The processing VMs 120 receive indications of audit events from multiple sources 110 (e.g. clusters). The sources 110 may be, for example, sources of stored indications of audit events and/or computing systems configured to automatically generate indications of audit events. The processing VMs 120 are thus configured to process audit events from multiple sources. The system may distribute the audit events between processing VMs 120. The audit events can be sent to some or possibly all processing VMs 120. The VMs then process audit events. Single audit events can be processed in parallel by multiple VMs. The system may further be configured to hash audit records for immutable recording purposes, as will be described elsewhere herein. The system is further configured to send to information to a blockchain to support for audit ledger recording. The system is further configured to translate between audit record formats. The system is further configured to add query metadata to audit records. The system is further configured to store the audit records on distributed storage nodes 140. The storage nodes can include computing devices having memory, databases, etc. The storage can be provided on computer nodes with multiple hard drives or other storage media, for example. Various such actions of the system can be carried out by the processing VMs 120. An HDFS file system can be used to manage the record storage, for example.

A computing device or VM can receive audit events and distribute them to the processing VMs. This computing device can correspond to the input module of the system. This computing device or VM can select a number of processing VMs and/or identities of processing VMs to receive each audit event based on a variety of conditions monitored by the computing device or VM. This may include an indication of capacity of processing VMs, importance of audit event information, and timing information, such as an amount of time to be taken to process an audit event.

In some embodiments, a networked arrangement of processing VMs 120 connected in a series-parallel configuration can be provided. Some VMs may operate in parallel while other VMs may operate in series. VM processing capacities can be differently set to avoid undesired bottlenecks. VMs operating in parallel are substantially independent of one another, in that the input to one parallel VM does not depend on the output from another parallel VM. For a first and second VM operating in series, input to the second VM depends on output from the first VM. VMs may be in series or parallel with respect to the configuration of inputs and outputs of data to be processed thereby. Data may be passed between VMs in the series-parallel configuration passing messages along real or virtual communication links. A communication link can comprise, for example, a shared memory location that can be written to one VM and read by another VM. Data can be encoded and physically communicated between devices using one or more of a variety of networking and communication protocols.

A user interface (UI) is provided via another VM 130. The UI can be used for command and control of the system.

The system may perform translation to alternate file systems, for example a ZFS™ file system, to scale out the storage format of the on-disk format.

In various embodiments, format translation can be performed and metadata added to records, in order to facilitate relational queries applied to field data. The metadata can be stored as database information which can be queried. Metadata can be extracted from the data being processed, received from an external metadata source (such as a clock, location, or system status information), or a combination thereof.

In various embodiments, data protection can be added to data stored in storage nodes 140 to guard against loss of node or disk protection.

The number of processing VMs 120 can be adjusted to scale audit log processing capabilities according to demand. A supervisory computer or VM can be used to perform such adjustment. The multiple VMs 120 are also provided to maintain availability of the system and different VMs 120 may be deployed on different physical hosts to provide for audit log processing availability, for example in the event of host device or network system failures. The number of storage nodes 140 can also be adjusted.

As such, embodiments of the present invention comprise receiving and processing audit events, for example using a scalable system comprising multiple processing VMs 120 operatively coupled to multiple storage nodes 140. The processing VMs can also transmit data to the storage nodes using real or virtual communication links and using one or more of a variety of networking and communication protocols.

Embodiments of the present invention can include some or all of the following operations: log processing, clustering, transformation operations, structured query operations, and immutable stamping. Unique file access records are transformed by parsing the file path into its constituent directories, and generating a new set of records, one per directory. Metadata associated with a file access event, such as user ID, time, and event type are stored with each directory record. Full event information is only stored with one record, keyed by the file's full path.

According to various embodiments, the system splits incoming events into processing paths based on provided information such as indexed attributes of the events path in the filesystem, user security identifier, and security event types. A supervisory computer or VM can receives and processes the provided information and routes the events to a processing path using a set of rules specifying correspondence between provided information and processing paths. The processing path can include one or more processing VMs. The set of rules can be static or the set of rules can vary over time, for example based on a current system status.

In some embodiments, the supervisory computer or VM performs initial, limited processing on the received event information and determines attributes of the received events. The supervisory computer or VM then selects one or more particular processing VMs based on determined attributes and transmits the received events to these processing VMs for handling.

Processing VM's 120 serialize audit events received thereby into another level of serial processing based on a user security identifier. The events are cloned again for parallel processing of behavior patterns for known security events.

Security event patterns are based on weighted values for each behavior type. Parallel events are processed and combined into an overall behavior assessment to determine if the behavior is malicious. Each of the processing VMs performs separate data processing, and the combined processing by multiple VMs produces data indicative of security event attributes.

Malicious events are indexed to the user, files and dates and times to build a security event record and written to the audit database and added to the blockchain in the audit record ledger.

The ledger may be a database that stores audit records in a file format leveraging a distributed physical storage node with disks to store portions of the database tables. Details of the audit record storage are provided below.
a. The on-disk format index records within individual files that represent a subset of the table data.
b. The distributed storage nodes assist with accelerating queries to the tables by allowing processing nodes to break down a query into smaller queries that are sent to each storage node for local processing.
c. The results are returned to the processing nodes to be combined and returned as a result.
d. Query performance increases with the number of storage nodes used for the audit ledger database.
e. Writing records is also handled by breaking events into smaller updates and assigning handling of the updates to the storage node that is responsible for the region of the table based on the audit event index.
f. A portion of the audit database stores blockchain records that are used to provide for the creation of immutable, validated entries, which cannot be modified. Such blockchain records may be used to allow for validation of entries in the audit database. In some embodiments, all entries in the audit database are recorded in the blockchain. The audit record ledger process is described below as records are written to the audit database by processing nodes.

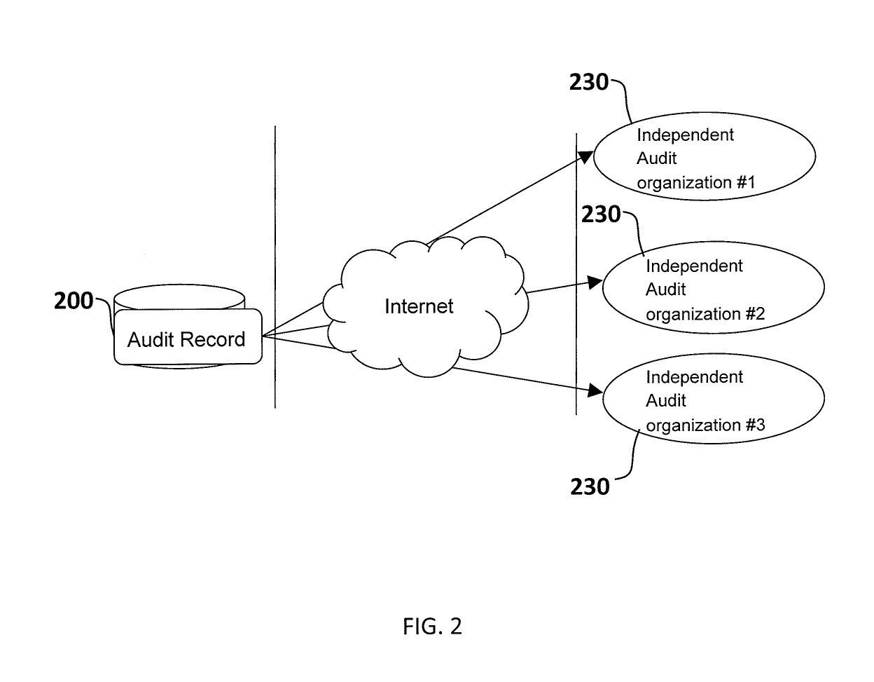

The audit record ledger validation process requires immutable stamping of a record or group of records using blockchain technology. This process begins by hashing a record or group of related records (by time, user, file or path) and computing a hash against all fields in the record. See FIG. 2 for the logical layout of external audit validation and acknowledgement. Referring to FIG. 2:
a. The processing nodes are seeded with a globally unique random number that represents the audit database's presence in the blockchain, so it can be identified in the blockchain.
b. The globally unique number is assigned by external auditors to the enterprise entity deploying the audit platform.
c. All audit hash records submitted to the blockchain ledger include this globally unique number.

In more detail, FIG. 2 illustrates distribution of audit record information, according to an embodiment of the present invention. An audit record 200 stored in the system is subjected to a hashing operation. The audit record and/or hash can be indicative of the following information related to an audit event: user ID, access details, date and time of access, IP address, file name accessed, file type, etc. The hash of the audit record is sent, for example via the Internet, to more than one blockchain organization. This is used to immutably record the audit. Independent audit organizations 230 are shown.

The hash of a group of audit records is sent to the blockchain external servers to store the transaction in the ledger. A processing node stores a copy of the ledger in the audit database while replicating the hash transaction to remote ledgers hosted by independent audit companies. This allows external auditors to validate the hash of the audit record while refraining from storing the data at the external auditor premises or providing the external auditors access to the original record.

Under an audit of a customer's audit system, an on-site auditor is provided with access to the data via a user interface that is connected to the processing nodes that allows searching for audit data based on various relational queries of user, action, file, file type, data range, etc. . . . . A real-time validation of the results can be attained by checking the blockchain for each audit record returned to verify the record is deemed immutable and not modified to satisfy data integrity of the audit records.

Audit records are only committed to the storage systems once the local ledger server has replicated its ledger to remote audit instances of the blockchain ledger.

This acknowledgment function can operate synchronously or asynchronously, depending on the volume of audit transactions that require external audit compliance traceability.

The system can allow only a subset of the audit data to require auditor validation using policies on user, path or filename pattern.

Optimized, parallel queries are available to the auditor. The records are uniformly distributed across the nodes in the system, allowing independent processing of different regions of data. Pre-optimized fast queries can populate a live GUI for the system. Other, slow queries can be run in parallel across the system's storage nodes.

The blockchain refers to a distributed database that maintains a growing list of ordered records, each including a link to a previous block and a timestamp. The data in a blockchain is substantially immutable, e.g. resistant to modification or deletion. This is due to the blockchain's structure and configuration, as would be readily understood by a worker skilled in the art. Embodiments of the present invention comprise creating and maintaining a blockchain which comprises information which can be used to validate audit records. In various embodiments, the audit records pertain to access events performed on stored data. The information held in the blockchain may be limited, encrypted and/or obscured, so that potentially sensitive data is not discernible from the blockchain itself.

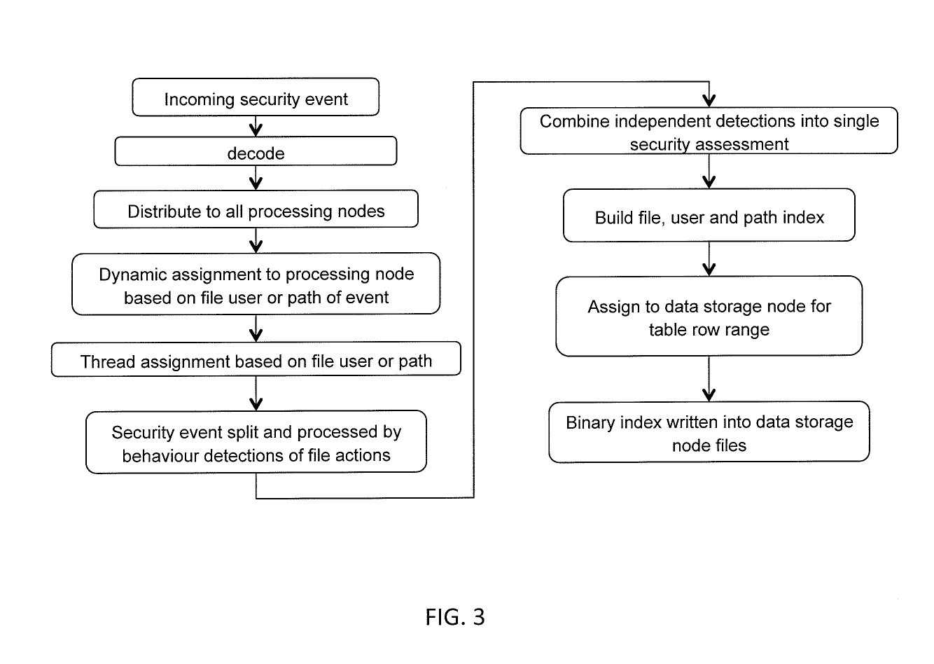

FIG. 3 illustrates operations related to transformation and processing of a record into a query structure and regional components, according to an embodiment of the present invention. Security events are processed as follows. An incoming security event is received, decoded and distributed to processing nodes. The security event is dynamically assigned for handling by a processing node, based on file, user, and/or file path information related to the event.

Multiple parallel code execution paths and/or threads are assigned processing task based on the events file, user or file path information. Next, security event information can be split (duplicated) and processed (e.g. in parallel) by behavior detection functions operating on the file actions described in the security event information. The independent detections are then combined to provide a security assessment of the security event.

Further, file, user and path indices are built to provide a security event record. The record is assigned to a data storage node, and a binary index is written into the data storage node files.

In one embodiment, an index applied to portions of a file path has multiple (e.g. three) indexes created for each directory. Cross indexing may be provided to a user account that accesses files in the directory paths. User access and file access records may be joined to support different variations on the join between user and directory. An example file path is “/fs/directory1/child1.”

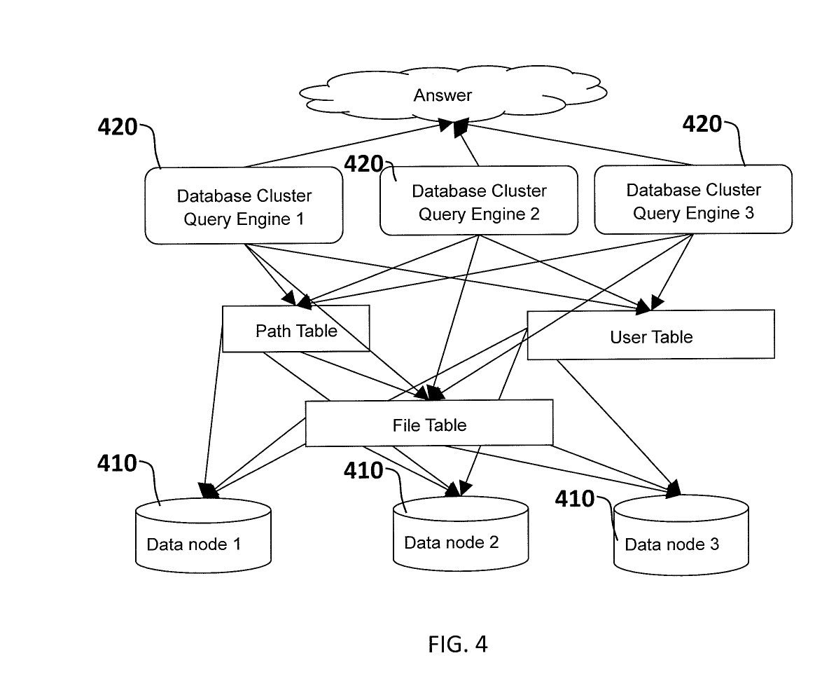

FIG. 4 illustrates a relational query structure which can act on multiple records, potentially stored in multiple data (storage) nodes 410, according to embodiments of the present invention. Queries can be spread through multiple query engines 420 that read data from multiple tables spread across multiple storage nodes 410. A query engine may be implemented using a computer processor operatively coupled to a memory and a network interface and configured to generate and transmit queries according to computer program instructions.

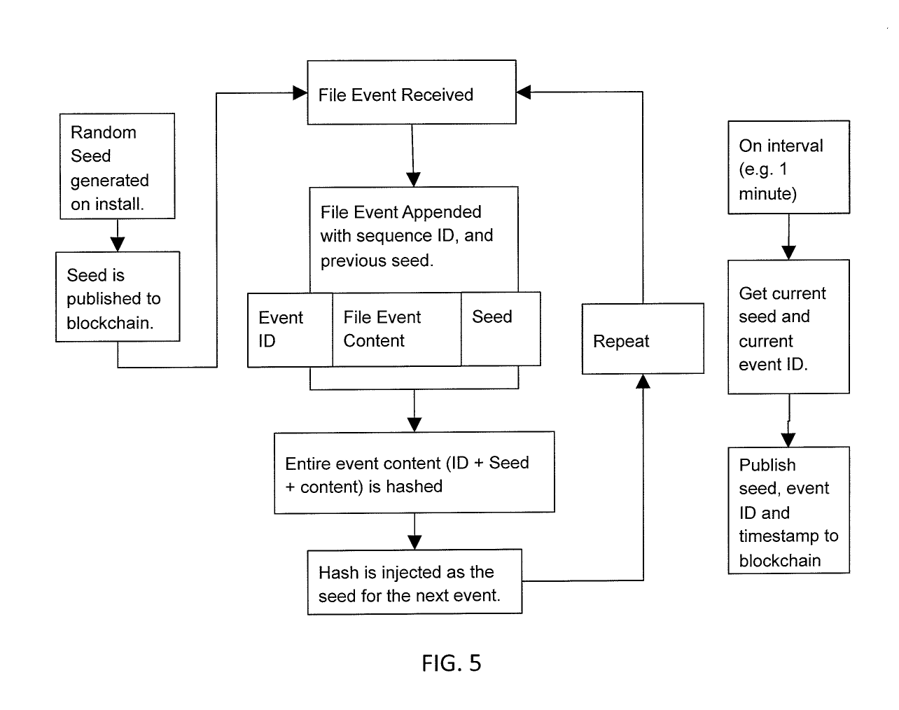

FIG. 5 illustrates operations related to cryptographically signing and securing a consecutive series of audit events, according to an embodiment of the present invention. It is noted that these operations may result in publishing a limited amount of data to the blockchain. These operations are automatically performed by a computer or a VM.

Referring to FIG. 5, in an initialization set of steps, a random seed is generated, installed, and published to the blockchain. An operating set of steps then proceeds as follows. Upon receipt of file events, the file event is appended with a sequence ID and the previous seed. (The seed is the random seed or a hash, as described below.) A record comprising an event ID, file event content, and the seed is generated. The entire event content is then hashed, and the hash is injected as the seed for the next file event. This operating set of steps is repeated as subsequent file events are received.

Concurrently, at predetermined intervals (e.g. 1-minute intervals), the current seed and current event ID is obtained, and the seed, event ID and a current timestamp is published to the blockchain.

As will be readily understood based on the above description, embodiments of the present invention provide for a system for processing audit records with translation to distributed parallel storage nodes for data protection from disk or node failures.

As will be readily understood based on the above description, embodiments of the present invention provide for a system for processing audit event streams on parallel physical nodes to track and identify single user behaviors that indicate malicious activity by processing file actions.

As will be readily understood based on the above description, embodiments of the present invention provide for a system of identifying malicious file activity with chained event types in sequences (read, write, rename, delete, create, modify) to construct malware security events of encrypting or manipulating files on a NAS system.

As will be readily understood based on the above description, embodiments of the present invention provide for a method to construct file access patterns that can detect encryption of files from audit events across distributed processing nodes.

As will be readily understood based on the above description, embodiments of the present invention provide for a method to organize data on a file system that allows relational query of the audit data to join multiple fields within the audit records and span any time period.

As will be readily understood based on the above description, embodiments of the present invention provide for a method to store audit data records that allows parallel nodes to query the data, with queries running on multiple physical compute and storage nodes.

As will be readily understood based on the above description, embodiments of the present invention provide for a system to separate processing nodes from storage nodes on physical machines.

As will be readily understood based on the above description, embodiments of the present invention provide for a system that allows query performance to scale with record count in a linear fashion.

As will be readily understood based on the above description, embodiments of the present invention provide for a system that stores security event data in a searchable indexed format that allows queries to be serviced by distributing a query to multiple nodes regardless of the total record count in the audit database.

As will be readily understood based on the above description, embodiments of the present invention provide for a system that provides lossless translation of security events under equipment failure, ensuring no audit event is lost.

As will be readily understood based on the above description, embodiments of the present invention provide for a system configured to submit an audit record or group of audit records to a blockchain to allow independent validation of an audit record by public ledger that shared between multiple entities.

As will be readily understood based on the above description, embodiments of the present invention provide for a method for hashing one or a group of related transformed audit records to submit to an internal or external Blockchain ledger of transactions.

As will be readily understood based on the above description, embodiments of the present invention provide for a method for cryptographically signing a consecutive series of audit events to ensure immutability using a distributed blockchain.

As will be readily understood based on the above description, embodiments of the present invention provide for a method for publishing a subset of audit event data to a blockchain, while maintaining audit data integrity for all records.

As will be readily understood based on the above description, embodiments of the present invention provide for a system that allows a shared blockchain maintained by multiple legal enterprise entities with no direct relationship to share third party external auditors, for the purpose of validating the blockchain transactions of audit events generated by separate legal enterprise entities.

As will be readily understood based on the above description, embodiments of the present invention provide for a method for searching records and validating the result is present in the blockchain indicating the result set passes the audit requirement of immutable audit data.

As noted above, embodiments of the present invention include an appropriately configured computer or network of computers, configured to operate as described herein to receive, process and provide computer data. Each computer may include a processor, a memory, and a network interface. The memory holds computer data and/or program instructions for execution by the processor in order to operate as described herein. In some instances, dedicated data processing hardware or a combination of hardware and firmware can be used in place of, or in addition to the processor and memory.

The present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. The software product may additionally or alternatively include a number of instructions that enable a computer device to execute operations for configuring or programming a digital logic apparatus in accordance with embodiments of the present invention. Processing circuitry, storage management circuitry, and other circuitry described herein may refer to a computer processor operatively coupled to memory, or other digital electronic circuitry configured to carry out logical data processing operations.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. An electronic system for processing audit events associated with computer file systems comprising:
a plurality of real or virtual computer processors configured to process audit event data indicative of interactions with the computer file systems in order to detect undesired instances of said interactions, each of the processing modules comprising processing circuitry;
a data input computer device comprising a data interface and configured to receive the audit event data and provide the audit event data to one or more of the plurality of processing modules for processing, the input module comprising further processing circuitry;
one or more electronic storage devices configured to receive and store output of the plurality of processing modules, each of the storage modules comprising an electronic data storage medium.

2. The system of claim 1, wherein the one or more electronic storage devices comprise multiple electronic storage devices accessible in parallel to receive, store and subsequently provide the output of the plurality of real or virtual computer processors.

3. The system of claim 1, wherein the one or more electronic storage devices is configured to store audit data.

4. The system of claim 3, wherein the audit data is stored using a lookup key derived from the audit data to allow sequentially related information to be stored on disk physically located within the same file and allow indexing of this lookup key for searching.

5. The system of claim 4, wherein the lookup key is based on security information, optionally selected from user identification, date and time of event, protocol of the action to the file system, hash of the file system path, and user security identifier.

6. The system of claim 4, wherein the lookup key points to the physical record on the disk and summarize.

7. The system of claim 4, wherein the lookup key is audit security specific and is configured to allow security searches to execute in parallel across multiple electronic storage thereby enabling faster searches.

8. The system of claim 1, wherein the data input computer device is configured to provide the audit event data to at least two of the plurality of real or virtual computer processors, the at least two of the plurality of real or virtual computer processors configured to process the audit event data for different patterns and in parallel.

9. The system of claim 8, wherein the at least two of the plurality of real or virtual computer processors are each configured to process the audit event data for detection of a different pattern indicative of undesired interaction with the computer file systems.

10. The system of claim 1, wherein some or all of the plurality of real or virtual computer processors are provided using virtual computing machines.

11. The system of claim 1, further comprising a scaling manager computer device configured to adjust an amount of computing resources used to support the plurality of processing modules, an amount of electronic storage resources used to support the plurality of storage modules, or both.

12. The system of claim 1, further comprising a behavior assessment computer device configured to receive, combine and process output of the plurality of real or virtual computer processors to determine indications of undesired behavior(s) corresponding to the audit event patterns processed by different logic.

13. The system of claim 1, further comprising storage management circuitry operatively coupled to one or more electronic storage devices and configured to:
distribute storage of the output of the plurality of real or virtual computer processors across the one or more electronic storage devices such that audit record data indicated in said output is retrievable in parallel in response to a predetermined type of query performable on the audit record data using the lookup key.

14. The system of claim 1, further comprising:
processing circuitry configured to generate blockchain data indicative of the audit event data; and
a network interface configured to transmit the generated blockchain data to a plurality of blockchain organizations.

15. An apparatus for storing audit record data, the audit record data indicative of interactions with a computer file system, the apparatus comprising storage management circuitry operatively coupled to a plurality of data storage media and configured to:
distribute storage of the audit record data across the plurality of data storage media such that the audit record data is retrievable in parallel in response to a predetermined type of query performable on the audit record data.

16. The apparatus of claim 15, wherein the predetermined type of query is run by breaking the query into parallel sub-queries, each of the parallel sub-queries targeting different portions of the audit record data, and wherein distributing storage of the audit record data comprises storing said different portions on different ones of the plurality of data storage media accessible in parallel by the sub-queries.

17. The apparatus of claim 15, wherein storing the audit record data comprises generating a plurality audit records each corresponding to a different file system path of the computer file system, and wherein each of the plurality of audit records is accessible by specifying a corresponding file system path.

18. The apparatus of claim 15, further comprising plural query engines and a query management module, the query management module configured to decompose a database query into plural sub-queries and provide the sub-queries to the plural query engines, the plural query engines configured to operate in parallel to query the plural data storage media based on the sub-queries.

19. An apparatus for maintaining audit record data indicative of interactions with a computer file system, comprising:
processing circuitry configured to generate blockchain data indicative of the audit record data; and
a network interface configured to transmit the generated blockchain data to a plurality of blockchain organizations.

20. The apparatus of claim 19, wherein the blockchain data comprises hashes of the audit record data.
